(19) United States
(12) Patent Application Publication
(10) Pub. No.: US 2017/0113428 A1
(43) Pub. Date: Apr. 27, 2017

(54) TYRE CARCASS BUILDING DRUM AND OPERATING METHOD OF SAID TYRE CARCASS BUILDING DRUM

(71) Applicant: MARANGONI MECCANICA S.P.A., Rovereto (IT)

(72) Inventors: Viscardo Baldoni, Rovereto (IT); Flavio Boscolo, Trambileno Fraz. Porte (IT); Danilo Pizzini, Rovereto (IT)

(21) Appl. No.: 15/128,284

(22) PCT Filed: Mar. 24, 2015
(86) PCT No.: PCT/IB2015/052159

§ 371 Date: Sep. 22, 2016

(30) Foreign Application Priority Data
Mar. 24, 2014 (IT) TO2014A000240

(51) Int. Cl. B29D 30/24; B29D 30/32; B29D 30/26

(52) U.S. Cl. CPC B29D 30/244; B29D 30/26; B29D 30/32; B29D 2030/2614; B29D 2030/3214

(57) ABSTRACT

A tyre carcass building drum (1) having a longitudinal axis (3) and two half-drums (6) movable along the longitudinal axis (3) in opposite directions away from and towards a centre plane (4) of the drum (1), each one comprising a bead carrying device (16) defining a saddle and a turn-up device (41) designed to turn up a annular side portion (42) of a carcass ply around, and on the outside of a respective bead ring; the turn-up device (43) having an end portion arranged, at rest, along a peripheral annular portion (18) of the saddle (17) and shaped so as to define an extension of the curvilinear profile of the saddle (17); and thrust means (50) being provided to directly and independently exert an axial thrust and a radial thrust on the turn-up device (43). The invention also relates to an operating method of said drum.

### TECHNICAL FIELD

The present invention relates to a drum for building a tyre carcass.

### BACKGROUND ART

In general, for manufacturing tyres for vehicles, or rather tyres comprising a carcass provided with two bead rings, it is known to use a building drum equipped with two half-drums coaxial to each other, these being movable in opposite directions along a common longitudinal axis under the thrust of a central actuating device.

Each half-drum comprises an expandable bead-locking device, which is movable, under the thrust of an actuating device, in a substantially radial direction with respect to the above-mentioned longitudinal axis, away from and towards an expanded locking position of a respective bead ring in a certain axial position along the relevant half-drum and radially external to an associated carcass ply of the tyre under construction, placed on the building drum in an initially outstretched position.

Each half-drum further comprises a turn-up device that, after operation of the bead-locking device and the formation of a torus-like shape in a central portion of the carcass ply comprised between the two bead rings, is activated to turn up a respective annular side portion of the carcass ply around, and on the outside of, the respective bead ring.

The operation of turning up the indicated side portions is critical because it requires perfect adhesion of the annular side portions on the respective sides of the torus-shaped central portion.

The known art reveals numerous solutions for the turn-up device based, for the most part, on the use of turn-up air bladders or of mechanical lever systems.

### DISCLOSURE OF INVENTION

The object of the present invention is to provide a perfected drum for forming a tyre carcass, this drum being capable of turning up multi-component composite structures.

According to the present invention, a tyre carcass building drum is provided as set forth in claim 1 and, preferably, as set forth in any of the subsequent claims directly or indirectly dependent on claim 1.

### BRIEF DESCRIPTION OF THE DRAWINGS

The invention shall now be described with reference to the accompanying drawings, which illustrate a non-limitative embodiment, in which:

FIG. 1 shows, in side elevation and partially in section, a preferred embodiment of the drum according to the present invention arranged in two different operating configurations;

FIGS. 2 to 4 show a detail of the drum in FIG. 1 in respectively different operating configurations; and

FIG. 5 shows, in a perspective view and with parts removed for clarity, the drum of FIG. 1 in two different operating configurations.

### BEST MODE FOR CARRYING OUT THE INVENTION

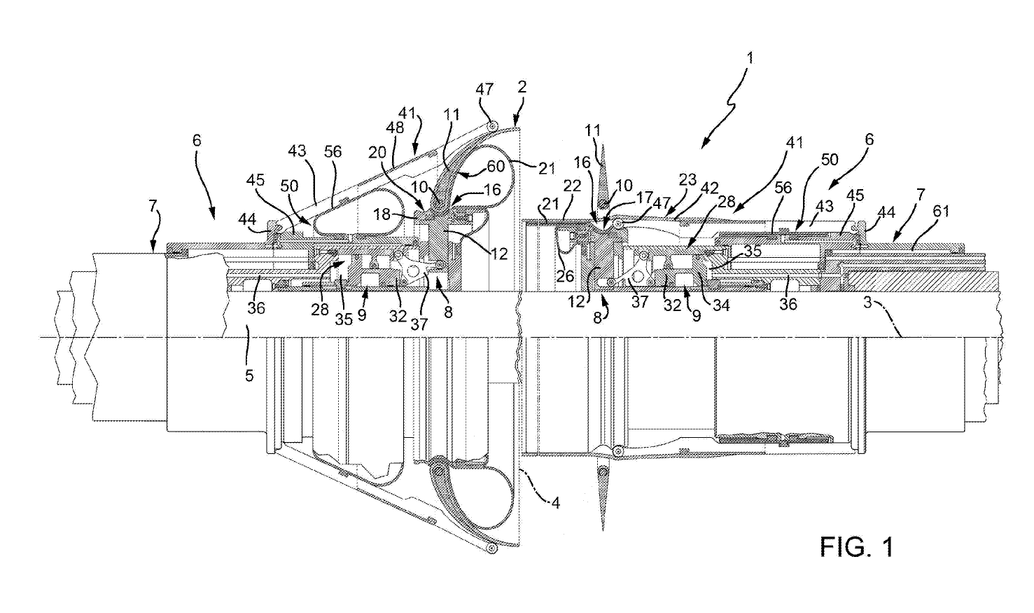

In FIG. 1, reference numeral 1 indicates, as a whole, a drum for building a carcass 2 of a tyre (not shown).

The drum 1 has a longitudinal axis 3 and a centre plane 4 perpendicular to the longitudinal axis 3, and comprises a tubular central shaft 5, which is coaxial to the longitudinal axis 3 and is mounted on known supports (not shown) to rotate about the axis 3 under the thrust of known actuating means (not shown).

The drum 1 further comprises two half-drums 6, which are arranged in specular positions with respect to the centre plane 4, are coaxial to the longitudinal axis 3, and are axially movable in opposite directions along the central shaft 5, away from and towards the centre plane 4, under the thrust of actuating means (known and not shown).

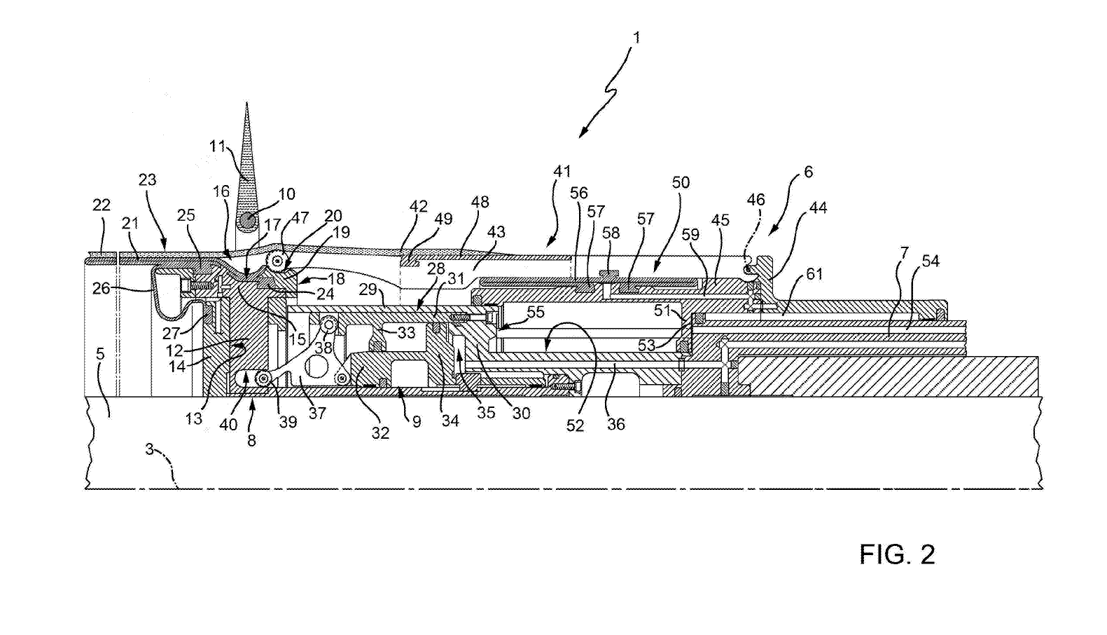

In particular, as better shown in FIGS. 2 to 4, each half-drum 6 comprises a respective tubular body 7, which is coupled in an axially sliding manner to the central shaft 5 and carries, connected at the axial end of the tubular body 7 facing the centre plane 4, a respective expandable locking device 8 designed to be operated, in use, by a respective actuating device 9 to lock a respective bead ring 10, equipped with a respective annular bead filler strip 11, onto the tubular body 7.

As better shown in FIGS. 2 to 4, the locking device 8 comprises a ring of pins 12, each of which slidingly engages a respective radial seat 13 made in an annular end flange 14 of the tubular body 7 portion. For each pin 12, the locking device 8 further comprises a grooved sector 15, which lies on a plane common to all the other grooved sectors 15 perpendicular to the longitudinal axis 3, is arranged with its cavity radially facing the outside of the drum 1 and forms, together with the other grooved sectors 15, an annular bead carrier 16, the outer surface of which defines an annular saddle 17 coaxial to the longitudinal axis 3 and designed to receive a respective bead ring 10 and lock it in position.

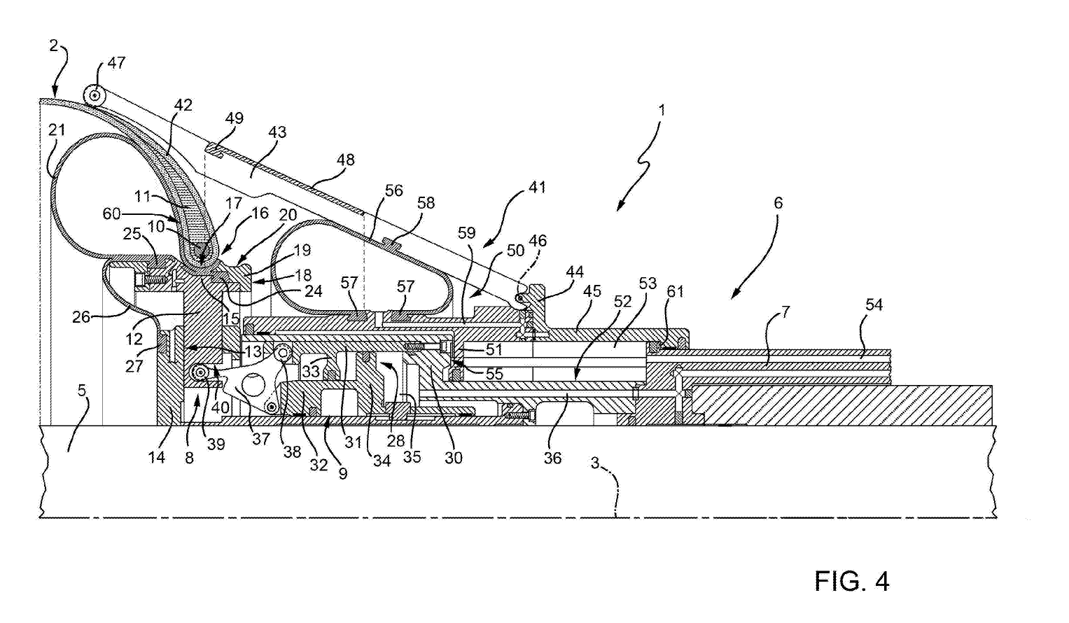

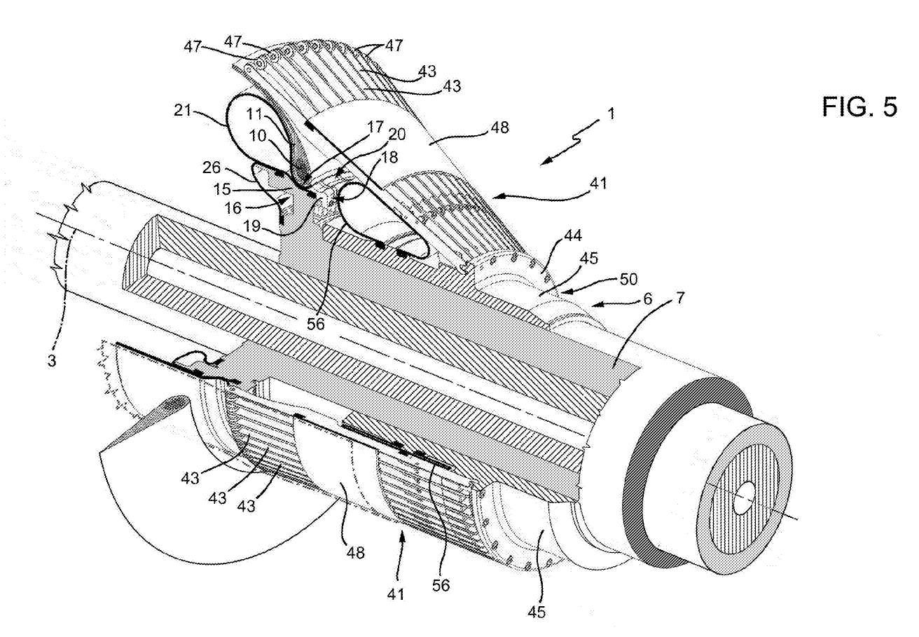

As better shown in FIGS. 4 and 5, the bead carrier 16 has, along its axially outer perimeter, an annular appendage 18 comprising a plurality of grooved bodies 19, each of which is integrally fastened to a respective grooved sector 15 and has, on its outer surface, a cavity defining, with the cavities of the other grooved bodies 19, a concave annular seat 20 coaxial to the longitudinal axis 3.

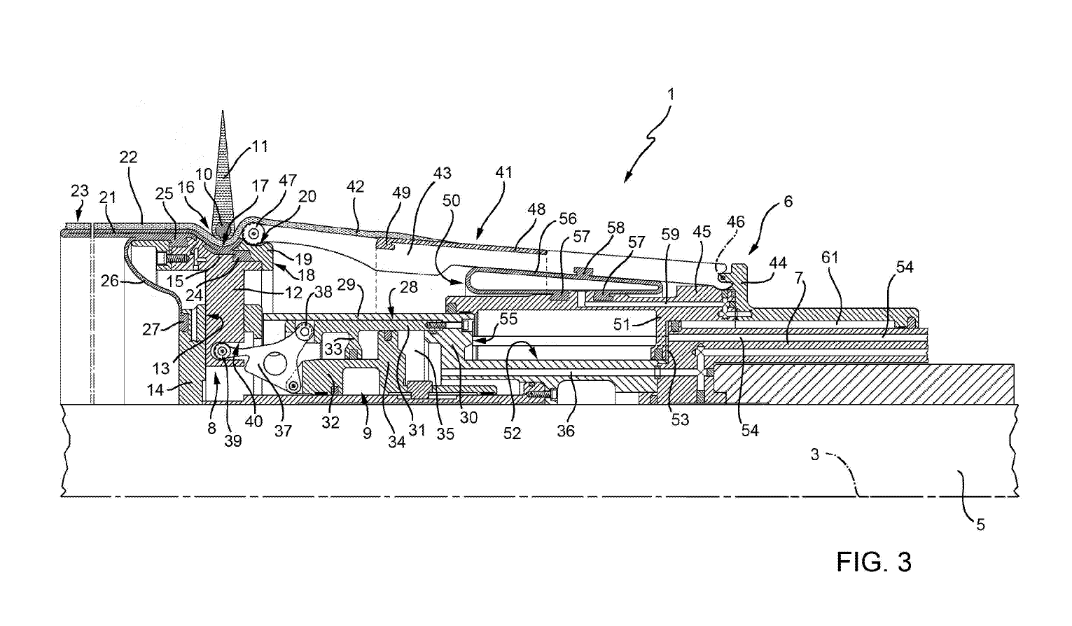

At the axial end facing the centre plane 4 and axially inside the associated locking device 8, each tubular body 7 carries a respective connected thrust bladder 21, which is located beneath a tubular central portion 22 of a carcass ply 23 wound around the drum 1 and is supplied, in use, with compressed air to move from a rest configuration (FIGS. 2 and 3), in which it is U-folded and extends flattened under the tubular central portion 22, to an expanded operating configuration (FIGS. 1, 4 and 5), in which the bladder 21 gives, together with the other bladder 21, a toroidal shape to the tubular central portion 22 comprised between the two bead rings 10.

As shown in FIG. 2, a first annular end portion of each bladder 21 extends over the associated saddle 17 and is integrally connected to the associated bead carrier 16 by a first annular coupling shoe 24 inserted in an annular seat made between the bead carrier 16 and the associated annular appendage 18; a second annular end portion of the bladder 21 is integrally connected to the bead carrier 16 by a second annular coupling shoe 25 engaged in a respective annular groove made on the bead carrier 16 on the opposite side of the saddle 17 with respect to annular coupling shoe 24. In addition, close to annular coupling shoe 25, the bladder 21 carries a connected annular sealing membrane 26, which is arranged radially inside the bladder 21, is connected to flange 14 by a further annular coupling shoe 27 engaged in a respective annular groove made on flange 14 and has the function of preventing leakage of pressurized air from the torus-shaped tubular central portion 22.

With reference to FIGS. 2 to 4, the actuating device 9 of the locking device 8 comprises an annular pneumatic cylinder 28, which is housed inside a metal tube 29 integral with the tubular body 7, is radially limited in the outward direction by an annular flange 30 of the tubular body 7 and comprises a tubular sleeve 31 rigidly connected to flange 30 by screws. The pneumatic cylinder 28 further comprises a fluid-tight annular piston 32 movable through a hole coaxial to the longitudinal axis 3 and defined by an annular flange 33, projecting radially inwards from an inner surface of the tubular sleeve 31. The piston 32 is coupled in a sliding and fluid tight manner to the tubular body 7 and is limited at its outer axial end by an annular wall 34, which is coupled in a sliding and fluid tight manner to the tubular sleeve 31 and defines, with annular flange 33 and the tubular sleeve 31, a variable-volume chamber 25, inside which compressed air can be fed, through a duct 36 made in the tubular body 7, to impart reciprocating motion to the piston 32 along the longitudinal axis 3.

At the opposite end with respect to the annular wall 34, the piston 32 carries a connected plurality of actuating members, each of which cooperates with a respective pin 12 to raise and lower the pin 12 in response to a displacement of the piston 32, and so impress, together with the other actuating members, a reciprocating radial motion to the bead carrier 16. Each actuating member therefore represents a positive guide and control member for the respective pin 12 and is defined by a triangular plate 37, which is hinged at one vertex to the piston 32 and, at the other two vertices, has respective rollers 38 and 39, the axes of which are transversal to the longitudinal axis 3. In particular, roller 38 slidingly engages, in the radial direction, an annular groove coaxial to the longitudinal axis 3 and made on the tubular sleeve 31, and roller 39 slidingly engages, in the axial direction, an annular groove 40 coaxial to the longitudinal axis 3 and made in the base of the associated pin 12. In use, when the piston is displaced from its normal rest position (FIG. 2) towards the bead carrier 16 following the supply of compressed air to the chamber 25, the travel of the piston 32, due to the constraint created by the rollers 38 engaged in the respective grooves, results in roto-translation of the plates 37, which, via the associated rollers 39, impress outward thrust on the respective pins 12, in this way causing the radial expansion of the bead carrier 16. Inversely, the retraction of the piston 32 causes the lowering of the pins 12 and the return of the bead carrier 16 to the initial, non-expanded position.

As shown in FIG. 1, for each half-drum 6, the drum 1 further comprises a respective turn-up device 41 with the function of turning up a respective annular side portion 42 of the carcass ply 23 around, and on the outside of, the respective bead ring so as to make the annular side portion 42 adhere on the respective annular side of the tubular central portion 22 previously shaped into a torus.

In particular, as better shown in FIGS. 2 to 5, the turn-up device 41 comprises a ring of longitudinal turn-up rods 43, which are uniformly distributed around the longitudinal axis 3, lie on respective planes passing through the longitudinal axis 3 and are operable, in use, to simultaneously move from a normal, outstretched rest position (right-hand side of FIG. 1 and lower part of FIG. 5), in which the turn-up rods 43 are substantially parallel to the longitudinal axis 3, and a raised operating position (left-hand side of FIG. 1 and upper part of FIG. 5), in which the turn-up rods 43 are radially rotated outwards and, taken as a whole, define a cone diverging towards the centre plane 4.

To this end, each turn-up rod 43 is hinged at its axially outer end to an annular flange 44 of a slide 45, which is common to all the turn-up rods 43, to oscillate about a respective axis 46 perpendicular to the plane on which the turn-up rod 43 lies. At the opposite axial end, each turn-up rod 43 carries a respective connected idle roller 47, mounted to turn about a respective axis parallel to the associated axis 46 and defining a pressure member designed to always stay in contact with the carcass ply 23 during the turn-up of the associated annular side portion 42. When the turn-up rods 43 assume the above-mentioned outstretched rest position, the rollers 47 are positioned in and supported by the annular seat 20. The radial position of the annular seat 20 with respect to the saddle 17 and the size of the rollers 47 are opportunely chosen in such a way that when the rollers 47 are inside the annular seat 20, their outer cylindrical surface defines a radial extension of the curvilinear profile of the saddle 17.

The turn-up rods 43 are connected together by a tubular elastic membrane 48, which is fitted around an intermediate portion of the turn-up rods 43, is axially locked on the turn-up rods 43 by respective coupling shoes 49 inserted in respective annular grooves made on the outer surface of the turn-up rods 43, and has the dual function of holding the rods in the correct position with respect to each other and to aid their return from the raised operating position to the normal rest position.

The slide 45, on which the turn-up rods 43 are pivoted, is part of a thrust device 50 designed to operate on the turn-up rods 43 to apply an axial force and a radial force directly on the turn-up rods 43.

In particular, as shown in FIGS. 2 to 4, the slide 45 of each half-drum 6 is defined by a tubular body coaxial to the longitudinal axis 3 and coupled in a sliding and fluid tight manner to an intermediate portion of an outer surface of the respective tubular body 7 to move with a reciprocating motion, together with the turn-up rods 43 taken as a whole and under the thrust of pneumatic actuating means, along the longitudinal axis 3 between a retracted position (FIG. 2), in which the two slides 45 of the drum 1 are at the maximum distance from each other and the turn-up rods 43 assume the above-mentioned outstretched rest position, and an advanced position (FIG. 4), in which the two slides 45 of the drum 1 are at the minimum distance from each other and the turn-up rods 43 assume the above-mentioned raised operating position. To this end, the slide 45 is provided with an annular flange 51, which projects radially inwards from an intermediate portion of the inner surface of the slide 45 and engages, in a sliding and fluid tight manner, an outer annular cavity 52 of the tubular body 7 to define, within the annular cavity 52, a variable-volume chamber 53 designed to be fed with compressed air through a duct 54 made in the tubular body 7.

As shown in FIG. 4 in particular, the inner axial end of the annular cavity 52 opposite to the chamber 53 defines a radial shoulder 55 designed to cooperate, in use, with annular flange 51 to limit the operative outward travel of the slide 45 towards the centre plane 4.

For each half-drum 6, the thrust device 50 further comprises an annular tubular bladder 56 that, at rest (FIG. 2), lies on top of a front portion of the slide 45 and beneath the turn-up rods 43 and, when expanded (FIG. 4), has a generic toroidal shape. The tubular bladder 56 is connected to the slide 45 by two annular coupling shoes 57 engaged in respective annular grooves made on the outer surface of the slide 45 and is connected to the turn-up rods 43 by a coupling shoe 58 inserted inside grooves made on the surface of the turn-up rods 43 facing the slide 45. The tubular bladder 56 is supplied, in use, with compressed air through a duct 59 made in the tubular body 7 and completely independent from the duct 54 supplying air to the thrust chamber 53 of the slide 45.

In use, a carcass ply 23 is wound around the drum 1 set in its rest position, shown in FIGS. 1 (right-hand side) and 2, in which the two half-drums 6 are arranged at a maximum distance from each other and the bladders 21 are deflated. In this position, the carcass ply 23 rests on the bead carriers 16 set in the their non-expanded or retracted position and the turn-up device 41 is in a non-operative configuration, in which the tubular bladder 56 is deflated, the slide 45 is in the retracted position and the turn-up rods 43 are in their outstretched rest position, supported on their respective rollers 47 inserted in the annular seat 20. Furthermore, in this position each of the two annular side portions 42 of the carcass ply 23 extend outwards from the respective bead carrier 16 and over the turn-up rods 43. Then, a respective bead ring 10 is fitted onto each half-drum 6 and on each annular side portion 42, and then locked in position by expanding the associated bead carrier 16 (FIG. 3) in the above-described manner. At this point, pressurized air is supplied, in a known manner, beneath the tubular central portion 22 and, at the same time, the two half-drums 6 are moved towards each other and towards the centre plane 4 to give the tubular central portion 22 the torus shape having two annular sides 60 substantially perpendicular to the longitudinal axis 3.

As shown in FIG. 3, the radial expansion of the bead carrier 16 also entails the radial expansion of the annular appendage 18 that, through the rollers 47 housed in the annular seat 20, impresses an outwardly directed radial force on the turn-up rods 43, which causes a slight rotation of the turn-up rods 43 about the respective axes 46. It should be noted that the expansion of the bead carrier 16 and the annular appendage 18 also results in an initial turning up of a base part of the annular side portion 42 around the bead ring 10. This initial turning up occurs passively under the action of the rollers 47, which, dragged radially outwards by the annular appendage 18, act like a fixed obstruction that, cooperating with the bead ring 10, forces the base of the annular side portion 42 to fold substantially upwards in an ‘L’ against the bead ring 10.

At this point, as shown in FIG. 4, pressurized air is supplied through duct 36 to each chamber 53, with the consequent displacement of the respective slide 45 towards the advanced position. At the same time, pressurized air is independently supplied through duct 59 to each tubular bladder 56.

The combined action of the slides 45 and the expansion of the tubular bladders 56 causes advancement towards the centre plane 4 and simultaneous radial expansion of the two sets of turn-up rods 43, the rollers 47 of which, held constantly in contact with the outer surface of the respective annular side portions 42, cause the progressive turning up of the annular side portions 42 against the respective sides 60.

One the turn-up of the annular side portions 42 is completed, the thrust device 50 is operated to return each set of turn-up rods 43 to their outstretched rest position. This operation is performed, for each half-drum 6, by interrupting the supply of pressurized air to the tubular bladder 56 and to the actuating chamber 53 of the slide 45, and by supplying pressurized air to a variable-volume chamber 61, which is obtained (FIGS. 2 and 3) between the outer cylindrical surface of the tubular body 7 and a tubular portion of the slide 45 axially external to flange 51 and is axially limited on one side by an outer annular flange projecting radially inwards from the end of the slide 45 and, on the other, by an inner annular flange projecting radially outwards from the tubular body 7 at a position adjacent to the shoulder 55. Prior to moving the slide 45 to its advanced position (FIGS. 2 and 3), chamber 61 is at its maximum volume and communicates with the outside through a feed duct (not shown). When the slide 45 is set in the advanced position (FIG. 4), the volume of chamber 61 is reduced to zero. If, starting from this point, pressurized air is supplied to chamber 61, the expansion of chamber 61 causes the return of the slide 45 to the retracted position, with the consequent emptying of chamber 53 and the tubular bladder 56 and, therefore, the return of the turn-up rods 43 to the outstretched rest position.

According to one variant, the thrust action imparted to the slide 45 by the expansion of chamber 61 can be increased by connecting chamber 53, through duct 54, to a suction device.

According to another variant, instead of using pneumatic thrust means, the slide 45 could be operated by any mechanical actuating device suitable for the purpose and which enables adjustment of the intensity and duration of the axial force applied.

With regard to that described in the foregoing, some considerations are appropriate:
the slide 45 and the tubular bladder 56 respectively define an axial thrust device and a radial thrust device, which is operatively independent of the axial thrust device and configured to act directly on the turn-up rods 43. It follows that it is possible to exert a radial force on the turn-up rods 43 of relatively high intensity and much greater than that which could be achieved, for the same axial force, if the radial force was exerted indirectly on the turn-up rods 43, for example, via actuating means operated by the axial thrust device. In fact, in this last case, the radial force acting on the turn-up rods 43 would be obtained through the division of the axial force applied by the axial thrust device and, therefore, a very high radial force would only be achievable through the application of an even higher axial force and such as to subject the carcass body to potentially damaging stresses.

The use of a radial thrust device able to apply a high radial force to the turn-up rods 43, independently of the axial thrust, enables turning up the annular side portions 42 in a particularly effective manner, especially in the case of carcass plies with high multilayer thicknesses and consequent strong resistance to circumferential expansion. This result is also achieved due to the position of the rollers 47 with respect to the saddle 17. In fact, the intensity of the radial force applied directly to the turn-up rods 43 is sufficient to enable the rollers 47 to apply a significant compression force on the base of the annular side portion 42 as soon as they are moved, in this way ensuring perfect adhesion of the material to the filler strip 11 and reducing the possibility of separation or the formation of wrinkles to a minimum.
the pneumatic type of actuation of the thrust device 50 enables modulating the forces of axial and radial thrust applied to the turn-up rods 43 during operation of the turn-up rods 43 via pressure modulation of the air supplied to chamber 53 and to the tubular bladder 56.

1-10. (canceled)

11. A tyre carcass building drum having a longitudinal axis, the tyre carcass building drum comprising:
two half-drums movable along the longitudinal axis in generally opposite directions from and towards a center plane of the drum, each of the two half-drums including:
a bead carrying device having an annular saddle movable away from and towards an expanded locking position of a respective bead ring; wherein the bead carrying device defines, on a ply of a carcass wound on the drum, a tubular central portion and two annular side portions; and
turn-up means operable to turn-up a respective said annular side portion around, and on the outside of, the respective bead ring; the turn-up means including a turn-up device and thrust means operable to directly and independently exert an axial thrust and a radial thrust on the turn-up device;
wherein the turn-up device has an end portion arranged, at rest, along a peripheral annular portion of said saddle and shaped so as to define a radial extension of the curvilinear profile of the saddle.

12. The tyre carcass building drum according to claim 11, wherein the turn-up device includes a plurality of longitudinal turn-up rods uniformly distributed around the longitudinal axis and lying in respective planes passing through the longitudinal axis; each turn-up rod being mounted to translate, with respect to the respective half-drum, along the longitudinal axis and to oscillate about a respective rotation axis substantially perpendicular to the plane on which the rod lies; the turn-up rods being provided, at the respective axial ends facing towards the center plane, with respective rollers mounted in a rotatable manner on respective turn-up rods and, taken as a whole, defining said end portion.

13. The tyre carcass building drum according to claim 12, wherein the thrust means include:
an axial thrust device adapted to translate the turn-up rods along the longitudinal axis; and
a radial thrust device adapted to oscillate the turn-up rods about respective rotation axes; the axial thrust device and the radial thrust device being operable independently one from the other.

14. The tyre carcass building drum according to claim 13, wherein the axial thrust device and the radial thrust device are configured to allow modulation of an intensity of the axial and radial thrusts exerted on the turn-up rods.

15. The tyre carcass building drum according to claim 13, wherein the radial thrust device includes a tubular bladder coaxial to the longitudinal axis and arranged beneath the turn-up rods, to apply, when expanded, a radial thrust directly to the turn-up rods, taken as a whole, which is directed towards the outside of the drum.

16. The tyre carcass building drum according to claim 13, wherein the axial thrust device includes a tubular slide coaxial to the longitudinal axis and coupled in an axially sliding and angularly fixed manner to the respective half-drum; the turn-up rods being connected to the slide by way of respective hinges to oscillate, with respect to the slide, about said rotation axis.

17. The tyre carcass building drum according to claim 16, wherein the axial thrust device includes pneumatic actuating means to move the slide along the longitudinal axis.

18. The tyre carcass building drum according to claim 16, wherein the tubular bladder is lying, at rest, over a front portion of the slide and beneath the turn-up rods and is connected to the slide and to the turn-up rods by way of respective coupling shoes.

19. An operating method of the tyre carcass building drum according to claim 15, comprising modulating the radial thrust imparted to the turn-up rods by way of the radial thrust device; said modulating the radial thrust comprising modulating the flow of compressed air supplied to the air chamber.

20. The operating method of a tyre carcass building drum according to claim 19, wherein the axial thrust device and the radial thrust device are operated independently of each other to move from respective rest positions to respective operating positions and perform, during this movement, the turn-up of the respective annular side portion; the return of the axial thrust device and of the radial thrust device to the respective rest positions being achieved by the application of a pneumatic type of active return force.
